(19) United States
(12) Patent Application Publication
(10) Pub. No.: US 2013/0268293 A1
(43) Pub. Date: Oct. 10, 2013

(54) HYGIENE COMPLIANCE SYSTEMS AND METHODS INCLUDING OPTICAL TAGS

(71) Applicants: Orlin B. Knudson, Vadnais Heights, MN (US); John M. Kruse, Minneapolis, MN (US)

(72) Inventors: Orlin B. Knudson, Vadnais Heights, MN (US); John M. Kruse, Minneapolis, MN (US)

(73) Assignee: 3M INNOVATIVE PROPERTIES COMPANY, ST. PAUL, MN (US)

(21) Appl. No.: 13/882,221

(22) PCT Filed: Dec. 21, 2011
(86) PCT No.: PCT/US11/66642

§ 371 Date: Apr. 29, 2013

Related U.S. Application Data
(60) Provisional application No. 61/428,634, filed on Dec. 30, 2010.

(51) Int. Cl. G06Q 50/22

(52) U.S. Cl. CPC G06Q 50/22; G06Q 10/0639
USPC 705/2

(57) ABSTRACT

Hygiene monitoring systems and methods are described herein. In various embodiments, the systems and methods may be used to monitor cleaning events (e.g., hand washing events, equipment sanitation events, etc.).

Non-compliance with recommended hygiene protocols such as washing or otherwise sanitizing hands before and after patient contact is thought to be a significant contributor in the spread of Healthcare Acquired Infections (HAI's). Each HAI adds cost and, in some instances, time to stays in hospitals and some medical care insurers, such as, e.g., Medicare, have indicated that they will not reimburse health care providers for health care expenses that are the direct result of at least some HAI's.

Monitoring compliance with hygiene protocols is, as a result, becoming increasingly important to assist health care facilities with measuring compliance with their hygiene protocols.

### SUMMARY

Hygiene compliance systems and methods are described herein in which optical identification tags including one or more optical indicia are associated with hygiene stations, patients, health care bundles, and other components in the system and used to monitor the occurrence of cleaning events and other activities associated with hygiene protocol compliance.

One of the potential advantages of the systems and methods described herein is the opportunity to retrofit existing resources such as, e.g., hand sanitizer dispensers, sinks with soap dispensers, etc. with identification tags that can be used to identify the characteristics of the different components. In particular, by using optical indicia on optical identification tags that can be detected using optical sensors carried by, e.g., a health care worker, a health care facility can be outfitted with the components needed to implement hygiene protocol compliance monitoring compliance in a relatively simple and relatively low-cost manner.

In a first aspect, some embodiments of a system for monitoring hygiene protocol compliance in a health care facility as described herein may include: a plurality of hygiene stations; an optical identification tag associated with each hygiene station of the plurality of hygiene stations, wherein the associated optical identification tag is located on or near the hygiene station and comprises optical indicia indicative of a characteristic of the hygiene station; a plurality of transient credentials, wherein each transient credential of the plurality of transient credentials comprises an optical sensor configured to detect the optical indicia on the optical identification tag associated with each hygiene station, and wherein the transient credential is configured to identify the characteristic of the hygiene station indicated by the optical indicia detected by the optical sensor; an optional controller, wherein the plurality of transient credentials are operably connected to the controller through a communication link that comprises communication devices in the plurality of transient credentials; wherein the system is configured to associate a cleaning event at a selected hygiene station with a selected transient credential based on detection of the optical indicia of the optical identification tag associated with the selected hygiene station by the optical sensor of the selected transient credential.

In some embodiments of the systems described herein, the system further comprises an optical identification tag associated with a patient in the health care facility, wherein the patient-associated optical identification tag is located on or near the patient and comprises optical indicia indicative of a characteristic of the patient; wherein the optical sensor of each transient credential of the plurality of transient credentials is configured to detect the optical indicia on the optical identification tag associated with the patient, and wherein the transient credential is configured to identify the characteristic of the patient indicated by the optical indicia detected by the optical sensor; wherein the system is configured to determine if the cleaning event at the selected hygiene station is a proper cleaning event for the patient based on the characteristic of the patient indicated by the optical indicia on the optical identification tag associated with the patient.

In some embodiments of the systems described herein, the system further comprises an optical identification tag associated with a health care bundle, wherein the bundle-associated optical identification tag is located on the health care bundle and comprises optical indicia indicative a characteristic of the health care bundle; wherein the optical sensor of each transient credential of the plurality of transient credentials is configured to detect the optical indicia on the optical identification tag associated with the health care bundle, and wherein the transient credential is configured to identify the characteristic of the health care bundle indicated by the optical indicia detected by the optical sensor; wherein the system is configured to determine if the cleaning event at the selected hygiene station is a proper cleaning event for the health care bundle based on the characteristic of the health care bundle indicated by the optical indicia on the optical identification tag associated with the health care bundle.

In some embodiments of the systems described herein, the characteristic identified by the optical indicia on the optical identification tag associated with a hygiene station comprises the location of the hygiene station.

In some embodiments of the systems described herein, the characteristic identified by the optical indicia on the optical identification tag associated with a hygiene station comprises the type of the hygiene station.

In some embodiments of the systems described herein, the characteristic identified by the indicia on the optical identification tag associated with a hygiene station comprises data identifying a patient associated with the hygiene station.

In some embodiments of the systems described herein, the optical indicia on the optical identification tag associated with a hygiene station is not a barcode.

In some embodiments of the systems described herein, each of the hygiene stations comprises two optical identification tags associated therewith, wherein each optical identification tag of the two optical identification tags comprises different optical indicia identifying a different characteristic of the hygiene station associated with the two optical identification tags.

In some embodiments of the systems described herein, the optical identification tags associated with the hygiene stations comprise adhesive for attachment to a surface on or near a hygiene station.

In some embodiments of the systems described herein, the optical sensor comprises a camera.

In some embodiments of the systems described herein, the transient credential comprises a light source emitting light of a selected wavelength.

In some embodiments of the systems described herein, the optical indicia selectively reflects or absorbs the light emitted by the light source.

In some embodiments of the systems described herein, the optical sensor and/or the optical indicia are configured to provide a distance determination indicative of the distance between the optical sensor and the optical indicia.

In some embodiments of the systems described herein, the controller comprises a patient zone controller, and wherein the system comprises data associating the patient zone controller with only one selected patient, and further wherein the patient zone controller is configured to define a patient zone proximate the selected patient.

In some embodiments of the systems described herein, the patient zone controller is configured to detect entry and/or exit of a transient credential of the plurality of transient credentials relative to the patient zone.

In another aspect, some embodiments of the methods of monitoring hygiene protocol compliance in a health care facility as described herein may include associating a plurality of optical identification tags with a plurality of hygiene stations, wherein at least one optical identification tag is associated with each hygiene station, wherein the at least one optical identification tag is located on or near the associated hygiene station and comprises optical indicia indicative of a characteristic of the associated hygiene station. Monitoring hygiene protocol compliance associated with a selected transient credential may include: identifying a characteristic of a selected hygiene station by detecting optical indicia on an optical identification tag associated with a selected hygiene station using an optical sensor of the selected transient credential; associating a cleaning event at the selected hygiene station with the selected transient credential based on detection of the optical indicia of the optical identification tag associated with the selected hygiene station by the optical sensor of the selected transient credential.

In some embodiments of the methods described herein, the method further includes associating an optical identification tag with a selected patient, wherein the optical identification tag is located on or near the selected patient and comprises optical indicia indicative of a characteristic of the selected patient. Monitoring the hygiene protocol compliance associated with the selected transient credential includes: identifying a characteristic of the selected patient by detecting optical indicia on the optical identification tag associated with the selected patient using an optical sensor of the selected transient credential; and determining if the cleaning event at the selected hygiene station is a proper cleaning event for the selected patient based on the characteristic of the selected patient indicated by the optical indicia on the optical identification tag associated with the selected patient.

In some embodiments of the methods described herein, the method further includes associating a plurality of optical identification tags with a plurality of health care bundles, wherein at least one optical identification tag is associated with each health care bundle, wherein the at least one optical identification tag is located on or near the associated health care bundle and comprises optical indicia indicative of a characteristic of the associated health care bundle. Monitoring the hygiene protocol compliance associated with the selected transient credential includes: identifying a characteristic of a selected health care bundle by detecting optical indicia on an optical identification tag associated with the selected health care bundle using an optical sensor of the selected transient credential; and determining if the cleaning event at the selected hygiene station is a proper cleaning event for the selected health care bundle based on the characteristic of the selected health care bundle indicated by the optical indicia on the optical identification tag associated with the selected health care bundle.

In some embodiments of the methods described herein, the characteristic identified by the optical indicia on the optical identification tag associated with a hygiene station comprises the location of the hygiene station.

In some embodiments of the methods described herein, the characteristic identified by the optical indicia on the optical identification tag associated with a hygiene station comprises the type of the hygiene station.

In some embodiments of the methods described herein, the characteristic identified by the indicia on the optical identification tag associated with a hygiene station comprises data identifying a patient associated with the hygiene station.

In some embodiments of the methods described herein, the optical indicia on the optical identification tag associated with a hygiene station is not a barcode.

In some embodiments of the methods described herein, each of the hygiene stations comprises two optical identification tags associated therewith, and identifying a characteristic of a selected hygiene station comprises identifying two different optical indicia on the two optical identification tags.

In some embodiments of the methods described herein, the optical identification tags associated with the hygiene stations are adhesively attached to a surface on or near a hygiene station.

In some embodiments of the methods described herein, the optical sensor comprises a camera.

In some embodiments of the methods described herein, the transient credential comprises a light source, and the method of identifying the optical indicia on the optical identification tags comprises emitting light of a selected wavelength.

In some embodiments of the methods described herein, the optical indicia selectively reflects or absorbs the light emitted by the light source.

In some embodiments of the methods described herein, the method further comprises determining a distance between the optical sensor and the optical indicia on the optical identification tags.

In some embodiments of the methods described herein, the controller comprises a patient zone controller, and the method comprises defining a patient zone proximate only one selected patient using the patient zone controller.

In some embodiments of the methods described herein, the method comprises detecting entry and/or exit of a transient credential of the plurality of transient credentials relative to the patient zone.

The words “preferred” and “preferably” refer to embodiments that may afford certain benefits, under certain circumstances. However, other embodiments may also be preferred, under the same or other circumstances. Furthermore, the recitation of one or more preferred embodiments does not imply that other embodiments are not useful, and is not intended to exclude other embodiments from the scope of the invention.

As used herein, “a,” “an,” “the,” “at least one,” and “one or more” are used interchangeably. Thus, for example, a hygiene station may be used to refer to one, two, three or more hygiene stations.

The term “and/or” means one or all of the listed elements or a combination of any two or more of the listed elements.

The above summary is not intended to describe each embodiment or every implementation of the systems and methods of monitoring hygiene protocol compliance in a health care facility as described herein. Rather, a more complete understanding of the systems and methods described herein will become apparent and appreciated by reference to the following Description of Illustrative Embodiments and claims in view of the accompanying figures of the drawing.

### BRIEF DESCRIPTION OF DRAWINGS

FIG. 1 depicts one illustrative embodiment of a system including a hygiene station in the form of a sink, a hand hygiene station in the form of a hand sanitizer dispenser, a patient, and a transient credential.

FIG. 2 depicts one illustrative embodiment of an optical identification tag including multiple optical indicia.

FIG. 3 depicts another illustrative embodiment of an optical identification tag including adhesive.

FIG. 4 depicts one illustrative embodiment of a system including multiple health care bundles, a transient credential, and a patient.

FIG. 5 depicts one illustrative embodiment of a system including multiple transient credentials, multiple patient zone controllers, and a central system controller along with a network through which the various components of the system may communicate.

### DESCRIPTION OF ILLUSTRATIVE EMBODIMENTS

In the following detailed description of illustrative embodiments, reference is made to the accompanying figures of the drawing which form a part hereof, and in which are shown, by way of illustration, specific embodiments in which the systems and/or methods may be practiced. It is to be understood that other embodiments may be utilized and structural changes may be made without departing from the scope of the present invention.

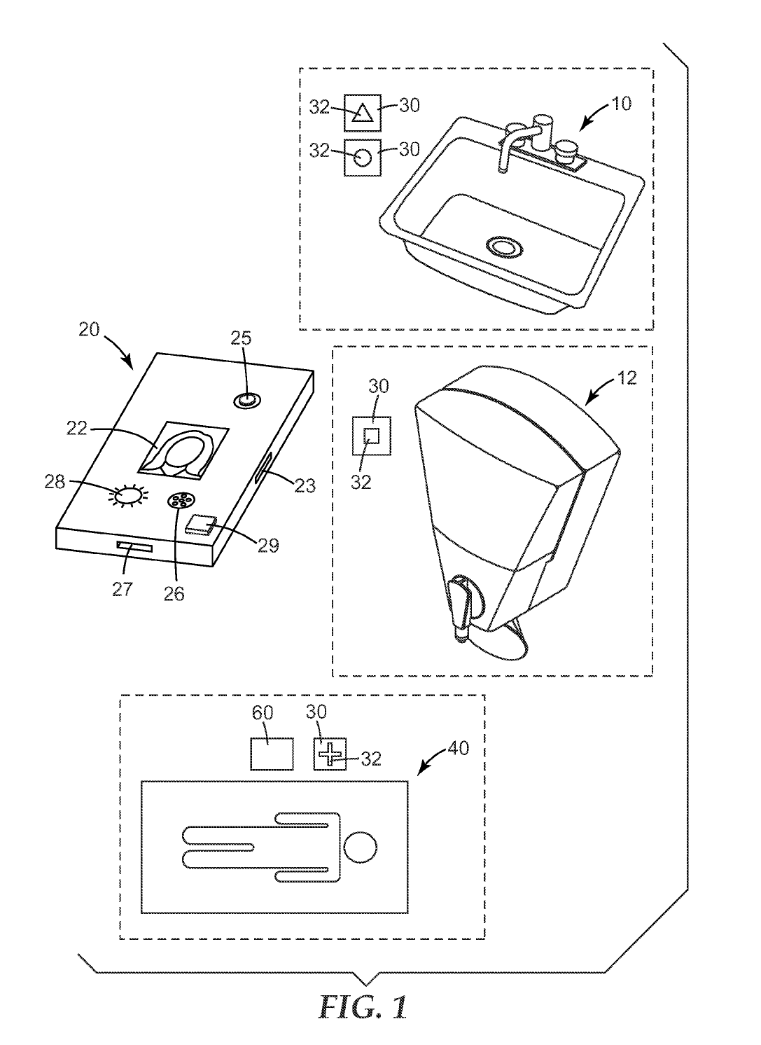

One illustrative embodiment of a system for monitoring hygiene protocol compliance in a health care facility is depicted in FIG. 1. The system depicted in FIG. 1 includes a hygiene station 10 in the form of a sink and soap dispenser, a hygiene station 12 in the form of a hand sanitizer dispenser, a transient credential 20, and a patient 40.

In addition, one or more optical identification tags 30 are associated with each of the hygiene stations 10 and 12 and the patient 40. The optical identification tags 30 include one or more optical indicia 32 that are indicative of one or more characteristics of the component with which they are associated. In other words, the optical indicia 32, when detected by, e.g., an optical sensor 25 on a transient credential 20, can be used to identify one or more characteristics of the hygiene station 10, hygiene station 12, and/or patient 40.

In the case of hygiene stations, the one or more characteristics that may be indicated by the optical indicia 32 on the optical identification tags 30 may include any selected characteristic including, but not limited to, the type of the hygiene station (e.g., whether the hygiene station is a sink with a soap dispenser, a hand sanitizing solution dispenser, an antibacterial ultraviolet light, a glove dispenser, etc.), the location of the hygiene station, etc. In the case of a patient, the one or more characteristics that may be indicated by the optical indicia 32 on the optical identification tags 30 may include any selected characteristic including, but not limited to, the specific identification of the patient, any particular conditions associated with the patient (e.g., is the patient afflicted with Clostridium difficile or some other condition that may require special hygiene protocol compliance measures), the location of the patient, etc.

One of the potential advantages of the systems and methods described herein is the ability of the system or method to use relatively simple techniques to identify the characteristics of the different components in the system and use those characteristics to monitor hygiene protocol compliance. In particular, by using optical indicia that can be detected using an optical sensor on the transient credential 20, a relatively simple approach can be taken to outfit a health care facility with the ability to monitor compliance with hygiene protocols using the identification tags 30 placed on or near existing equipment and/or on or near patients in a relatively simple and relatively low-cost manner.

The various components of the systems and methods may be configured to operate in manners as described herein to monitor hygiene protocol compliance within any selected health care facility. As used herein, the term “health care facility” may include a variety of environments including, for example, hospitals, long-term care facilities, health clinics, home health care environments, or any other patient-occupied setting.

In the depicted system, a hygiene station in the form of a sink and soap dispenser 10 is depicted along with a hygiene station in the form of a hand sanitizer dispenser 12. Although only two types of hygiene stations are depicted in the system of FIG. 1, it should be understood that the hygiene stations used in the systems and methods described herein may be any of a variety of different forms. Examples of some suitable hygiene stations that can be used to improve the hygiene of the hands of a health care worker, visitor, patient, etc. may include, e.g., sinks (with water and soap dispensers), antiseptic hand sanitizer dispensers, towelette dispensers (where the towelettes preferably include some form of suitable antiseptic cleanser), glove dispensers, UV disinfectant stations, etc. In the case of hand hygiene a cleaning event can be described as, e.g., a technique that can be used to provide a person with sanitary hands through, e.g., washing, the use of sanitizing materials/techniques, covering the hands using sterile gloves, etc.

In some embodiments, the hygiene stations used in the systems and methods described herein may be used to or be capable of cleaning equipment such as, e.g., monitoring/diagnostic equipment (e.g., blood pressure monitors, blood oxygen monitors, cardiac monitors, etc.), intravenous equipment (e.g., IV stands, infusion pumps, etc.); stethoscopes; etc. As used in connection with equipment, a cleaning event can be described as, e.g., a technique that can be used to sanitize appropriate portions of the equipment (e.g., the portions of a stethoscope that contact a patient or the hands of a user of the stethoscope, etc.).

Among the other components depicted in FIG. 1 are a transient credential 20 which, in the depicted embodiment, is in the form of a badge or other item that may be carried by or on a person. Other potentially suitable devices may include, e.g., personal data assistants (PDA's), cell phones (e.g. smart phones), or any other small computing device that includes the components and capabilities described for the transient credentials discussed herein. Examples of commercially available badge-based devices that could potentially be used for or form the basis for a transient credential as described herein in the form of a badge may be available from, e.g., Brick House Security, Inc. (www.brickhousesecurity.com, the ID Card Camera).

Although only one transient credential 20 is depicted in FIG. 1, the systems described herein may include more than one transient credential 20 that can be used in connection with the other components of the system to monitor compliance with hygiene protocols. Each of the transient credentials 20 used in the systems as described herein may be associated with a selected transient object, e.g., a person or a piece of equipment.

As described in, e.g., U.S. patent application Ser. No. 12/889,503, titled HYGIENE MONITORING SYSTEMS AND METHODS, filed on Sep. 24, 2010, and U.S. patent application Ser. No. 12/905,214, titled HEALTH CARE DELIVERY MONITORING SYSTEMS AND METHODS, filed on Oct. 15, 2010, the transient credentials may preferably include, in various embodiments, an optional communication device capable of transmitting and/or receiving data and on-board memory that is operably connected to the communication device to store received data and/or transmit stored data as a part of the operation of the system. The operable connection between the on-board memory and the communication device may typically be performed by a controller that is also preferably resident on or in the transient credential. Examples of some potentially suitable controllers may include, e.g., an Application Specific Integrated Circuit (ASIC) state machine, a gate array, a microprocessor, a microcontroller, etc.

In some embodiments, the one or more transient credentials 20 may be associated with a health care worker or other person (e.g., visitor, janitorial staff, etc.) present within the health care facility in which the system is used. The systems in which the transient credentials are used may include data associating a selected transient credential 20 with a selected person such that monitoring the compliance of that selected person with the hygiene protocols as described herein can be accomplished.

In some embodiments of the systems and methods described herein, one of the one or more transient credentials may be associated with a piece of equipment that, in a health care facility, is not in a fixed location in the health care facility. Examples of some types of equipment that may be associated with a transient credential may include, but is not limited to: stethoscopes, monitoring/diagnostic equipment (e.g., blood pressure monitors, blood oxygen monitors, cardiac monitors, etc.), intravenous equipment (e.g., IV stands, infusion pumps, etc.); etc. Associating a transient credential 20 with a selected piece of equipment in the systems described herein may be used for monitoring compliance with cleaning protocols for the selected pieces of equipment.

In some embodiments, the data associating the transient credential with a selected person or piece of equipment may be variable, i.e., may be changed as a part of the operation of the system by, for example, entering unique identification data when the transient credential is assigned to the selected person or piece of equipment. In other embodiments, the data associating the transient credential with a selected person or piece of equipment may be fixed, i.e., the transient credential may itself contain unique identifying data that is assigned to the selected person or piece of equipment when the transient credential is issued or otherwise associated with the selected person or piece of equipment.

Although generally described as being associated with a selected person or a piece of equipment, in some embodiments the same transient credential may be associated with multiple objects at the same time, e.g., one or more people and/or one or more pieces of equipment. In such a situation, the system would be configured to detect and associate a cleaning event for each of the associated people and/or pieces of equipment as a part of hygiene protocol compliance monitoring as discussed herein. Where the two different associated objects require different cleaning events, e.g., a person requires a hand cleaning event and a stethoscope requires an equipment cleaning event, the system may preferably be configured to detect that each of the different cleaning events takes place as required.

The transient credential 20 may also include a variety of different components. In the depicted illustrative embodiment, the transient credential 20 includes identification information 22 which may include a picture, name, and other identifying information for a person associated with the transient credential 20 (when the transient credential 20 is in the form of a badge). In addition, the depicted transient credential 20 also preferably includes an optical sensor 25, a speaker or other audio output device 26, a light source 28, a secondary optical sensor 27, and an actuator 29.

The optical sensor 25 of the transient credential 20 may be in a variety of different forms, although it may be preferred that the optical sensor 25 be in the form of a camera capable of capturing still or video image data that may be used in the methods described herein to monitor hygiene compliance. Further, the transient credential 20 may include a controller and image processor that are capable of processing images obtained using the optical sensor 25 to identify objects in the images (e.g., the optical indicia 32 on any optical identification tags 30 in the images obtained).

The optional audio output device 26 may be used to deliver information to, e.g., a person carrying the transient credential 20. For example, the speaker 26 may be used to provide tones or other sounds indicative of proper or improper practices by the person associated with the transient credential 20.

The optional secondary optical sensor 27 may be used to obtain information from optical indicia in a different manner than can be obtained using the primary optical sensor 25. For example, the secondary optical sensor 27 may be more efficient at or capable of obtaining data from barcodes, micro dots, or other optical indicia that may be more amenable to a scanning process where the primary optical sensor 25 is in the form of a camera. Alternatively, however, it should be understood that the secondary optical sensor 27 may not be necessary where the primary optical sensor 25 is capable of obtaining information optically in any form required within a given system.

The optional light source 28 depicted in connection with the illustrative embodiment of a transit credential 20 may be provided for a variety of functions. For example, the light source 28 may be used to provide visual indicators that may be indicative of proper or improper practices by the person associated with the transient credential 20. For example, the light source 28 may blink, flash, change color, or provide some other visual indicator that can be detected visually by a person viewing the transient credential 20.

In some embodiments, the light source 28 may emit light in one or more selected wavelengths that may be selectively absorbed and/or reflected to enhance detection of the optical indicia as described herein. For example, in some systems and methods described herein, the light source 28 may emit light in the near infrared spectrum that may be capable of passing through clothing to enhance the ability of the optical sensor 25 to detect optical indicia on the optical identification tags described herein even if the optical sensor of the transient credential is obscured by clothing.

Furthermore, the transient credential 20 may also include a port 23 through which data can be communicated to or from the various components on or in the transient credential. For example, the port 23 may be in the form of a USB, micro USB, IEEE 1494 FireWire port, or any other suitable connection for transferring data. The data port 23 may be operatively connected to memory and a controller resident on the transient credential 20 to effect any such data transfer.

In addition, the transient credential 20 may also include an actuator 29 that may, for example, be used to actuate one or more functions of the components associated with the transient credential 20. In some embodiments, the actuator 29 may be used to, e.g., obtain one or more images using the optical sensor 25 and/or the secondary optical sensor 27. Other functions that may be performed using the actuator 29 may include, for example, operation of the light source 28, data transfer using the port 23, etc. In some embodiments, the actuator 29 may also be used to clear an alert that may be provided using the transient credential 20 where, for example, a health care worker carrying the transient credential 20 may have made a mistake in a hygiene protocol that resulted in the delivery of an error signal. In such a situation the health care worker may have the opportunity to clear the alert after some action has been taken to address the situation that resulted in the alert.

The system depicted in FIG. 1 also includes a patient 40 and a patient zone controller 60. The patient 40, although shown in a bed, maybe ambulatory and/or in a wheelchair or in any other state. In other words, the systems and methods described herein are not limited to use with bedridden patients.

The patient zone controllers 60 of systems and methods described herein may preferably include, in various embodiments, a communication device capable of transmitting and/or receiving data and on-board memory that is operably connected to the communication device to store received data and/or transmit stored data as a part of the operation of the system. The operable connection between the on-board memory and the communication device may typically be performed by a controller that is also preferably resident on or in the patient zone controller. Examples of some potentially suitable controllers may include, e.g., an Application Specific Integrated Circuit (ASIC) state machine, a gate array, a microprocessor, a microcontroller, etc. The controller in a patient zone controller may also, in some embodiments, be used to control operation of the patient zone and other functions of the patient zone controller as described herein.

Each of the patient zone controllers 60 in the systems and methods described herein is preferably associated with only one patient through, e.g., data associating the patient zone controller with only one selected patient. In some embodiments, the data associating the patient zone controller with a selected patient may be variable, i.e., may be changed as a part of the operation of the system by, for example, entering unique patient identification data into the system when the patient zone controller is assigned to the selected patient. In other embodiments, the data associating the patient zone controller with a selected patient may be fixed, i.e., the patient zone controller may itself contain unique identifying data that is assigned to the selected patient when the patient zone controller is issued or otherwise associated with the selected patient. In either case, the unique identifying data (whether unique to the patient or the patient zone controller) may, in some systems, be used to facilitate maintenance of the associated patient's Electronic Medical Record (EMR) as a part of the hygiene monitoring.

The patient zone controllers of the systems described herein, such as patient zone controller 60, are also preferably configured to define one or more patient zones, where the patient zones define one or more areas in which entry into and/or exit of other components from the patient zone 60 (such as a transient credential 20) can be detected.

By “define” as used in connection with the patient zones defined by the patient zone controllers described herein, it is meant that a patient zone controller preferably includes the components (e.g., hardware, processors, software, sensors, transducers, etc.) required to establish, form, emit, etc. the patient zones described herein. While the patient zone controller may, in some embodiments, be provided as a one-piece integrated unit contained within a single housing, in other embodiments, the patient zone controller may take the form of two or more components such a main housing and operably connected emitters, sensors, etc. as required to define the patient zone(s) for the particular patient zone controller, where at least one of the components is not contained within the main housing.

The patient zones defined by the patient zone controllers of the systems described herein may preferably be large enough to contain a patient such that physical contact with the patient is typically not possible without a detectable entry into the patient zone, although in some instances as described herein, the size of the patient zone may be reduced such that the patient is not entirely contained within the patient zone to, e.g., facilitate patient movement within the health care facility, etc.

In some embodiments, the boundaries of the patient zones defined by the patient zone controllers 60 may be somewhat variable depending on the technology used to define the patient zone, i.e., the boundaries of the patient zone may not necessarily be distinct. Examples of some potentially suitable technologies that may be incorporated into the patient zone controller to define the one or more patient zones such that entry into and/or exit from the patient zone may be detected may include, for example, RF (Radio Frequency) reflection, acoustic reflection (using, e.g., ultrasonic energy, etc.), RFID (Radio Frequency Identification) detection, LIDAR (Light Detection and Ranging), infrared detection and/or imaging, optical imaging, capacitive detection, pressure sensing mats, etc.

More specifics regarding operation and configuration of patient zone controllers that may be used in conjunction with the other system components described herein may be found in, e.g., U.S. patent application Ser. No. 12/889,503, titled HYGIENE MONITORING SYSTEMS AND METHODS, filed on Sep. 24, 2010.

In summary then, the system for monitoring hygiene protocol compliance in a health care facility as depicted in FIG. 1 may include, in various embodiments, multiple hygiene stations 10 and 12 and one or more transient credentials 20. In addition, the system depicted in FIG. 1 also includes an optical identification tag 30 associated with each hygiene station 10 and 12. Each of the associated optical identification tags is located on or near the hygiene station with which it is associated and includes optical indicia 32 that is indicative of one or more characteristics of the hygiene station with which it is associated.

For example, the optical identification tags 30 associated with the sink and soap dispenser 10 may include optical indicia 32 which indicate that the hygiene station includes a sink and soap that can be used by a person to wash his or her hands. The optical identification tag 30 associated with the hygiene station 12 may indicate that the hygiene station is in the form of a hand sanitizer dispenser. In some embodiments, the optical indicia may indicate even more specific information such as, e.g., the type of hand sanitizer contained in the dispenser, the type of soap contained in a soap dispenser, etc. In some embodiments, the optical indicia 32 may indicate the location of the hygiene station, whether it is linked with another component in the system (e.g., a patient, a patient zone controller, etc.)

The optical sensor 25 of the transient credential 20 may preferably be configured to detect the optical indicia 32 on the optical identification tags 30 associated with the hygiene stations 10 and 12. Based on that detection, the transient credential 20 may be configured to identify the one or more characteristics of the hygiene stations that are indicated by the optical indicia 32 detected by the optical sensor 25.

The system depicted in FIG. 1 may be further configured to associate a cleaning event at a selected hygiene station 10 and/or 12 with the transient credential 20 when, for example, the optical sensor 25 of the transient credential 20 detects the optical indicia 32 of the optical identification tag 30 associated with a hygiene station. As one example, when a person wearing or otherwise using the transient credential 20 approaches a hygiene station 10 or 12, the optical sensor 25 may detect the optical indicia 32 on optical identification tag 30 by, e.g., collecting one or more images and processing those images to identify one or more selected objects in the image(s) that correspond to the optical indicia 32. Based on those selected objects, the system is capable of identifying one or more characteristics of the hygiene station associated with the optical identification tag 30.

Further, based on the proximity of the transient credential 20 to the optical identification tag 30, the system can be configured to make a determination that the person carrying the transient credential 20 performed a cleaning event at the hygiene station based on their proximity to the hygiene station alone.

In some embodiments, the optical sensor 25 on the transient credential 20 and its associated components (e.g., an image processor, controller, etc. carried on the transient credential 20) may be configured to determine the distance between the transient credential 20 and the optical identification tags 30 found in images obtained using the optical sensor 25. That distance determination may be used, at least in part, to make the determination that a person carrying the transient credential 20 should be associated with a cleaning event at the hygiene station associated with the detected optical identification tag (because, e.g., they were simply close enough to the hygiene station).

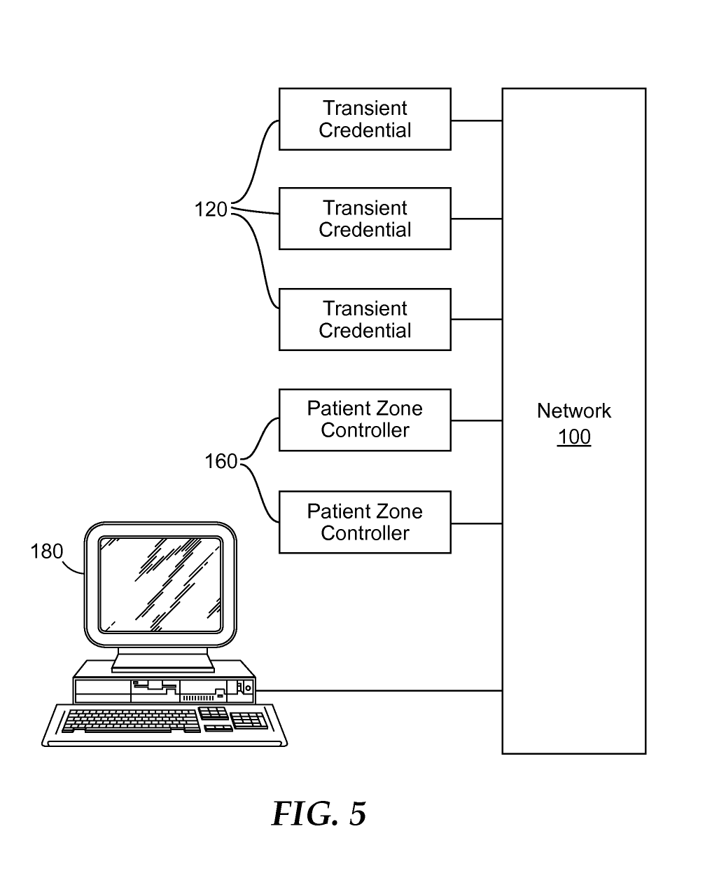

In some embodiments, the system may include a central controller (see, e.g., central controller 180 of FIG. 5) and the transient credentials 20 may be operably connected to the controller through a communication link using communication devices in the transient credentials 20 as described in connection with FIG. 5.

In the system of FIG. 1, one or more optical identification tags 30 may also be associated with a selected patient 40 in the health care facility. The patient-associated optical identification tag 30 may preferably be located on or near the patient 40 and, similar to the optical identification tags 30 associated with the hygiene stations 10 and 12, the optical identification tag 30 associated with the patient 40 may preferably include optical indicia 32 indicating one or more characteristics of the patient 40.

As with the optical identification tags 30 associated with the hygiene stations 10 and 12, the optical sensor 25 of the transient credential 20 is preferably configured to detect the optical indicia 32 on the optical identification tag 30 associated with the patient 40. Based on that detection, the transient credential 20 may be configured to identify the one or more characteristics of the patient that are indicated by the optical indicia 32 detected by the optical sensor 25.

The system depicted in FIG. 1 may be further configured to associate a cleaning event at a selected hygiene station 10 and/or 12 with the transient credential 20 and the patient 40 when, for example, the optical sensor 25 of the transient credential 20 detects the optical indicia 32 of the optical identification tag 30 associated with the patient 40 after determining that a cleaning event has occurred at one of the hygiene stations 10 or 12. As one example, when a person wearing or otherwise using the transient credential 20 approaches a patient 40, the optical sensor 25 may detect the optical indicia 32 on optical identification tag 30 associated with the patient 40 by, e.g., collecting one or more images and processing those images to identify one or more selected objects in the image(s) that correspond to the optical indicia 32. Based on those selected objects, the system is capable of identifying one or more characteristics of the patient associated with the optical identification tag 30.

Some systems and methods as described herein may, based on detection of the various optical indicia 32 on the different optical identification tags 30, be configured to determine if a cleaning event at a hygiene station 10 or 12 is a proper cleaning event for the patient 40 based on the characteristics of the hygiene station 10 or 12 used to perform a cleaning event as well as the characteristics of the patient 40 indicated by the optical indicia 32 on the optical identification tag 30 associated with the patient 40. For example, if the characteristic of the patient 40 that is indicated by the optical indicia 32 of the optical identification tag 30 associated with the patient 40 is that the patient has Clostridium difficile or some other condition for which proper hand sanitizing requires washing with soap and water, a cleaning event using hand sanitizing solution from a dispenser 12 would result in a determination that the a proper cleaning event has not occurred. Conversely, a cleaning event performed at the hygiene station 10 using soap and water would result in a determination that a proper cleaning event has occurred.

In still other embodiments, the optical indicia 32 identified on the optical identification tags 30 associated with hygiene stations and a patient may be used to identify a patient associated with a hygiene station. For example, in some systems and methods described herein, a proper cleaning event may require that a person associated with a transient credential 20 clean his or her hands at one or more selected hygiene stations within a system before and/or after working with a selected patient (where, for example, the patient has Clostridium difficile or some other condition for which proper hand sanitizing requires one or more selected hand sanitizing events to be considered effective or proper). This type of scenario may be described as one in which a hygiene station is linked to a particular patient within a given system.

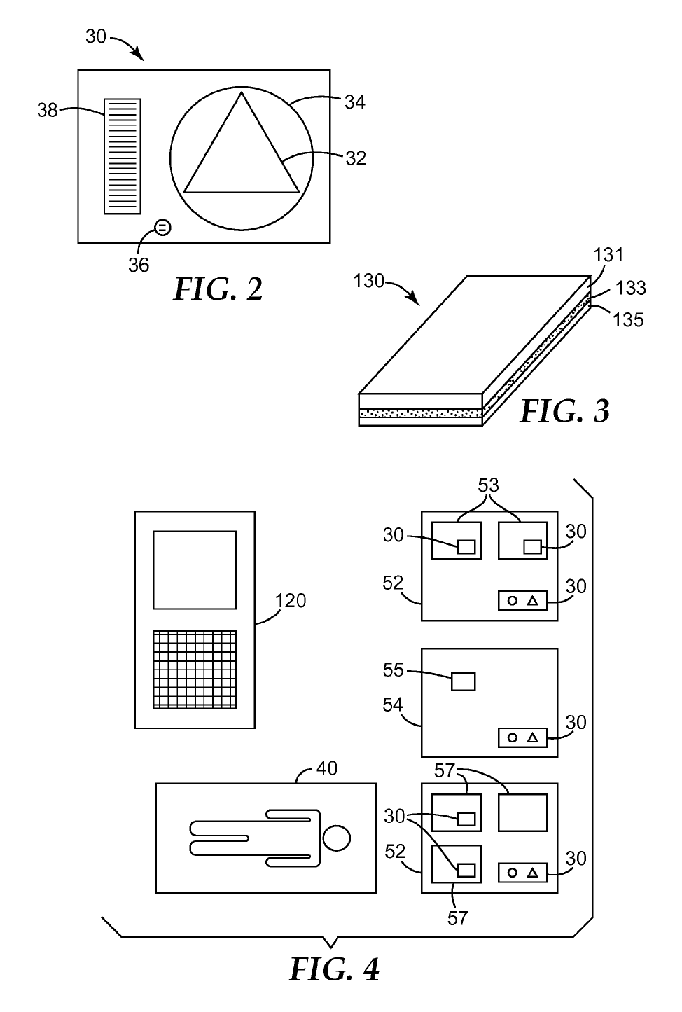

Referring to FIG. 2, another illustrative embodiment of an optical identification tag 30 is depicted. The optical identification tag 30 includes multiple different optical indicia that may be used to identify one or more characteristics of a component in a system that is associated with the optical identification tag. For example, the depicted optical identification tag 30 includes optical indicia 32 in the form of a triangle, optical indicia 34 in the form of a circle, optical indicia 36 in the form of a microdot, and optical indicia 38 in the form of a barcode. Among the variations depicted in FIG. 2 is that at least some of the optical indicia can be nested or superimposed on top of each other. For example, the optical indicia 32 and 34 are depicted as being superimposed on each other on the optical identification tag 30.

The microdot 36, although depicted as being located outside of any other particular optical indicia on the optical identification tag, may also be superimposed on any other optical indicia provided on the optical indication tag 30 so long as effective detection and identification of the microdot 36 is not prevented.

The optical indicia in the form of a barcode 38 may also be used to provide information identifying one or more characteristic as described herein. In at least some embodiments, use of a barcode may be in addition to one or more other optical indicia on an optical identification tag. For example, optical indicia that are simpler and/or quicker to read or detect may be used (e.g., optical indicia in the form of shapes, colors, etc.) to trigger an indication that further actions should be taken to obtain the information contained in, e.g., another optical indicia such as a barcode 38.

In some embodiments, the optical identification tags could use retroreflection (e.g., retroreflective sheeting, etc.) to potentially assist in identification of the optical indicia on the optical identification tags by screening out visual noise. Retroreflection may be more helpful if, e.g., the transient credential used to detect the optical indicia emits light as part of the identification process.

Referring to FIG. 3, yet another illustrative embodiment of an optical identification tag 130 is depicted. The optical identification tag 130 includes a substrate 131 a layer of adhesive 133 on at least one surface of the substrate 131 and, optionally, a liner material 135 the can be used to protect the adhesive 133 until the optical identification tag is adhesively attached to a selected surface as a part of the process of associating the optical identification tag 130 with a component in the system.

Another feature of the optical identification tags used in connection with the systems and methods described herein is that the shape of the substrate 131 of the optical identification tag 130 may, itself, form an optical indicia that can be detected by an optical sensor of a transient credential as described herein. In other words, the optical identification tags used in the methods and systems described herein may include optical indicia provided on a substrate in some embodiments (see, e.g., optical identification tag 30 depicted in FIG. 2), while in other embodiments, the optical identification tag may have a shape that is, itself, optical indicia that may be used to identify one or more characteristics of an associated component.

In those embodiments in which the optical identification tags used herein have an adhesive, the optical identification tags may be attached on or near selected components in a system using such an adhesive. It will, however, be understood that the adhesive may not necessarily be provided directly on the optical indicia, but may instead be separately provided from the optical identification tags. Further, it will be understood that the optical identification tags may be attached on or near the selected components using any suitable attachment technique, e.g., adhesives, mechanical fasteners, paints, inks, etc. For example, in some systems and methods the optical identification tags may be painted or stamped on existing surfaces such that a separate article (e.g., a substrate) is not required to be attached.

In addition, although the optical identification tags may be provided in the form of a substrate they can be attached to another surface, the optical identification tags may take a variety of other forms including, but not limited to, wristbands, armbands, medallions, hang tags, badges, etc. In any such embodiments, however, the optical identification tags preferably include one or more optical indicia that can be used to identify one or more characteristics of a component with which they are associated.

Referring now to FIG. 4, an alternative illustrative embodiment of a system is depicted in which health care bundles 52 and 54 may include one or more optical identification tags 30 that can be used to identify one or more characteristics of the different health care bundles. The system as depicted in FIG. 4 also includes at least one transient credential 120 and may also include a patient 40.

The “health care bundles” described herein are used in the delivery of health care to patients, where a health care bundle may be defined as “a group of interventions (practices) related to a disease process that, when executed together, result in better outcomes than when implemented individually.” As used herein, a health care bundle will typically, but not necessarily, include one or more physical items, a process that involves use of the one or more physical items, and, optionally, monitoring of the process of using the one or more physical items. Monitoring of the process may include monitoring the time between performance of different steps within a specific health care bundle delivery sequence and/or the time between delivery of discrete health care bundles. Health care bundles may be used throughout patient care, i.e., in the pre-, peri, and post-operative stages of health care.

The physical items of a health care bundle may include a kit (e.g., disposables such as catheters, alcohol wipes, drapes, hand cleaners, etc.), instruments (stethoscopes, environmental monitors, blood pressure monitors, etc.), or dispensers (hand sanitizer dispensers, sterile wipes, etc.). The processes included in health care bundles are steps used in delivering the health care associated with the health care bundle to a patient.

Health care bundles may be established for use with the delivery of almost any health care to a patient, including, but not limited to, e.g., urinary catheter care, intravenous catheter care, endotracheal tube care, instrument monitoring, delivery of medication, vital sign monitoring, environmental monitoring, etc.

As one example of a health care bundle, endotracheal tubes are used in combination with ventilators to assist patient respiration and may be the source of VAP (Ventilator Associated Pneumonia). A health care bundle for endotracheal tube care (sometimes referred to as a “VAP bundle”) may include physical items for providing oral care to the patient, as well as instructions regarding the processes to be implemented as part of the health care bundle (which may or may not actually involve use of the physical items in the health care bundle). Other health care bundles may be established for almost any other care to be provided to a patient.

As depicted in FIG. 4, the bundles 52 may include an optical identification tag 30 associated with the health care bundle as a whole in addition to optical identification tags 30 that are associated with specific items 53 and/or 57 that may be provided in the health care bundles 52. As a result, the optical sensor associated with a transient credential 120 may be used to detect the optical identification tags 30 that are associated with the health care bundle 52 as a whole, for example, at the start of a process in which the health care bundles is delivered to a patient. In addition, an optical sensor associated with the transient credential 120 may also be used to detect optical identification tags 30 that are associated with specific items 53 and/or 57.

Detection of the optical identification tags 30 associated with the health care bundles as a whole, as well as with specific items associated with the health care bundles, may be used to determine compliance with delivery protocols associated with the health care bundles. For example, the order in which the specific items 53 and/or 57 are used during delivery of a health care bundle may be determined based on when the different optical identification tags are detected by an optical sensor associated with the transient credential 120.

Furthermore, any specific delivery protocol requirements such as, e.g., specific handwashing requirements, etc. can be identified at the start of the health care bundle delivery process and/or during delivery of the health care bundle where, for example, the health care worker may be required to sanitize his or her hands at some intermediate point in the process of delivering the health care bundle.

The health care bundle 54 that is also depicted as part of the system of FIG. 4 is provided to show that a health care bundle 54 may be provided with only a single optical identification tag 30 even though that health care bundle 54 may include one or more specific items 55. In other words, the health care bundles 54 do not necessarily require optical identification tags on each and every specific item associated with a health care bundle. An example of this is also seen in the lowermost health care bundle 52 which includes a specific item 57 in its upper right-hand corner that does not include an optical identification tag.

In systems in which one or more optical identification tags are associated with a health care bundle, the optical identification tag may be located on any convenient surface. For example, the optical identification tag may be located on a package containing one or more items of the health care bundle, on a dispenser used to dispense the health care bundle, etc.

In a system such as that depicted in FIG. 4, the optical sensor of the transient credential 120 may preferably be configured to detect the optical indicia on the optical identification tags associated with the health care bundle and/or its items. Based on the identification of the optical indicia, the transient credential 120 may preferably be configured to also then identify one or more characteristics of the health care bundle that are indicated by the optical indicia on the optical identification tags.

Based on identification of the characteristics of the health care bundle, the system may further be configured to determine if, for example, a cleaning event at a selected hygiene station is a proper cleaning event for the health care bundle being delivered to a patient.

The system depicted in FIG. 4 may be used in the systems and methods described in U.S. patent application Ser. No. 12/905,214, titled HEALTH CARE DELIVERY MONITORING SYSTEMS AND METHODS, filed on Oct. 15, 2010.

Referring to FIG. 5, one embodiment of a system in which the transient credentials and optical identification tags described herein may be used to monitor hygiene compliance is depicted. Although in some systems and methods described herein only one transient credential may be used alone to monitor hygiene protocol compliance within a facility, in many instances it will be beneficial to provide multiple transient credentials along with other components such that health care protocol compliance may be monitored throughout a facility or at least within large portions of the facility.

The system may include multiple transient credentials 120, multiple patient zone controllers 160, and a central controller 180. Although a specific number of the different components are depicted in connection with the system of FIG. 5, it should be understood that the systems described herein may include any suitable number of the various components, for example, although the system depicted in FIG. 5 includes three transient credentials, a system as described herein may be implemented with fewer transient credentials 120 or any other number of transient credentials needed to provide the coverage desired within a given facility.

Although the system depicted in FIG. 5 includes patient zone controllers 160, it should be understood that systems as described herein may or may not include patient zone controllers and/or may include a different number of patient zone controllers. For example, the system may be implemented with only one patient zone controller 160 or with three or more patients own controllers 160.

The various components in the system depicted in FIG. 5 may preferably be operably connected to each other through a network 100 that provides for communication between the various components through any suitable communication protocol, e.g., wired, wireless, and any other form of communication. Examples of some potentially suitable networks and devices that communicate with them may be described in, e.g., U.S. Pat. Nos. 7,639,943; 6,847,334; 5,553,609; 6,122,526; etc.; as well as US Patent Application Publication No. US 2002/0108118 A1.

The optional central controller 180 that may be provided as a part of the system depicted in FIG. 5 may include, e.g., one or more data processing units and software operating to store and/or retrieve data that may be used by the various components during the methods described herein. For example, the central controller 180 may include components such as an image processor, memory, etc.

Although the processing of images obtained by the transient credentials as a part of operation of the systems and methods described herein may be preferably performed on the transient credentials themselves, in some systems the image processing may be performed by a more central unit such as an image processor incorporated into the central controller 180.

In some embodiments, the system may also include other components such as an administrative module that may be used for billing purposes, for inventory management, etc. based on data collected from detection of the optical indicia on the optical identification tags as described herein. Furthermore, other modules may be included in a system for record-keeping purposes, e.g., the system may interface with an Electronic Medical Records (EMR) system to assist in management of health care delivery to patients located within a facility.

### EMBODIMENTS

1. A system for monitoring hygiene protocol compliance in a health care facility, the system comprising: a plurality of hygiene stations; an optical identification tag associated with each hygiene station of the plurality of hygiene stations, wherein the associated optical identification tag is located on or near the hygiene station and comprises optical indicia indicative of a characteristic of the hygiene station; a plurality of transient credentials, wherein each transient credential of the plurality of transient credentials comprises an optical sensor configured to detect the optical indicia on the optical identification tag associated with each hygiene station, and wherein the transient credential is configured to identify the characteristic of the hygiene station indicated by the optical indicia detected by the optical sensor; an optional controller, wherein the plurality of transient credentials are operably connected to the controller through a communication link that comprises communication devices in the plurality of transient credentials; wherein the system is configured to associate a cleaning event at a selected hygiene station with a selected transient credential based on detection of the optical indicia of the optical identification tag associated with the selected hygiene station by the optical sensor of the selected transient credential.
2. A system according to embodiment 1, wherein the system further comprises an optical identification tag associated with a patient in the health care facility, wherein the patient-associated optical identification tag is located on or near the patient and comprises optical indicia indicative of a characteristic of the patient; wherein the optical sensor of each transient credential of the plurality of transient credentials is configured to detect the optical indicia on the optical identification tag associated with the patient, and wherein the transient credential is configured to identify the characteristic of the patient indicated by the optical indicia detected by the optical sensor; wherein the system is configured to determine if the cleaning event at the selected hygiene station is a proper cleaning event for the patient based on the characteristic of the patient indicated by the optical indicia on the optical identification tag associated with the patient.
3. A system according to embodiment 1, wherein the system further comprises an optical identification tag associated with a health care bundle, wherein the bundle-associated optical identification tag is located on the health care bundle and comprises optical indicia indicative a characteristic of the health care bundle; wherein the optical sensor of each transient credential of the plurality of transient credentials is configured to detect the optical indicia on the optical identification tag associated with the health care bundle, and wherein the transient credential is configured to identify the characteristic of the health care bundle indicated by the optical indicia detected by the optical sensor; wherein the system is configured to determine if the cleaning event at the selected hygiene station is a proper cleaning event for the health care bundle based on the characteristic of the health care bundle indicated by the optical indicia on the optical identification tag associated with the health care bundle.
4. A system according to any one of embodiments 1-3, wherein the characteristic identified by the optical indicia on the optical identification tag associated with a hygiene station comprises the location of the hygiene station.
5. A system according to any one of embodiments 1-3, wherein the characteristic identified by the optical indicia on the optical identification tag associated with a hygiene station comprises the type of the hygiene station.
6. A system according to any one of embodiments 1-3, wherein the characteristic identified by the indicia on the optical identification tag associated with a hygiene station comprises data identifying a patient associated with the hygiene station.
7. A system according to any one of embodiments 1-6, wherein the optical indicia on the optical identification tag associated with a hygiene station is not a barcode.
8. A system according to any one of embodiments 1-7, wherein each of the hygiene stations comprises two optical identification tags associated therewith, wherein each optical identification tag of the two optical identification tags comprises different optical indicia identifying a different characteristic of the hygiene station associated with the two optical identification tags.
9. A system according to any one of embodiments 1-8, wherein the optical identification tags associated with the hygiene stations comprise adhesive for attachment to a surface on or near a hygiene station.
10. A system according to any one of embodiments 1-9, wherein the optical sensor comprises a camera.
11. A system according to either of embodiments 1-10, wherein the transient credential comprises a light source emitting light of a selected wavelength.
12. A system according to embodiment 11, wherein the optical indicia selectively reflects or absorbs the light emitted by the light source.
13. A system according to any one of embodiments 1-12, wherein the optical sensor and/or the optical indicia are configured to provide a distance determination indicative of the distance between the optical sensor and the optical indicia.
14. A system according to any one of embodiments 1-13 wherein the controller comprises a patient zone controller, and wherein the system comprises data associating the patient zone controller with only one selected patient, and further wherein the patient zone controller is configured to define a patient zone proximate the selected patient.
15. A system according to embodiment 14 wherein the patient zone controller is configured to detect entry and/or exit of a transient credential of the plurality of transient credentials relative to the patient zone.
16 A method of monitoring hygiene protocol compliance in a health care facility, the method comprising: associating a plurality of optical identification tags with a plurality of hygiene stations, wherein at least one optical identification tag is associated with each hygiene station, wherein the at least one optical identification tag is located on or near the associated hygiene station and comprises optical indicia indicative of a characteristic of the associated hygiene station; and monitoring hygiene protocol compliance associated with a selected transient credential by: identifying a characteristic of a selected hygiene station by detecting optical indicia on an optical identification tag associated with a selected hygiene station using an optical sensor of the selected transient credential; associating a cleaning event at the selected hygiene station with the selected transient credential based on detection of the optical indicia of the optical identification tag associated with the selected hygiene station by the optical sensor of the selected transient credential.
17. A method according to embodiment 16, the method further comprising:

associating an optical identification tag with a selected patient, wherein the optical identification tag is located on or near the selected patient and comprises optical indicia indicative of a characteristic of the selected patient; wherein monitoring the hygiene protocol compliance associated with the selected transient credential comprises: identifying a characteristic of the selected patient by detecting optical indicia on the optical identification tag associated with the selected patient using an optical sensor of the selected transient credential; and determining if the cleaning event at the selected hygiene station is a proper cleaning event for the selected patient based on the characteristic of the selected patient indicated by the optical indicia on the optical identification tag associated with the selected patient.

18. A method according to embodiment 16, the method further comprising:

associating a plurality of optical identification tags with a plurality of health care bundles, wherein at least one optical identification tag is associated with each health care bundle, wherein the at least one optical identification tag is located on or near the associated health care bundle and comprises optical indicia indicative of a characteristic of the associated health care bundle; wherein monitoring the hygiene protocol compliance associated with the selected transient credential comprises: identifying a characteristic of a selected health care bundle by detecting optical indicia on an optical identification tag associated with the selected health care bundle using an optical sensor of the selected transient credential; and determining if the cleaning event at the selected hygiene station is a proper cleaning event for the selected health care bundle based on the characteristic of the selected health care bundle indicated by the optical indicia on the optical identification tag associated with the selected health care bundle.

19. A method according to any one of embodiments 16-18, wherein the characteristic identified by the optical indicia on the optical identification tag associated with a hygiene station comprises the location of the hygiene station.
20. A method according to any one of embodiments 16-18, wherein the characteristic identified by the optical indicia on the optical identification tag associated with a hygiene station comprises the type of the hygiene station.
21. A method according to any one of embodiments 16-18, wherein the characteristic identified by the indicia on the optical identification tag associated with a hygiene station comprises data identifying a patient associated with the hygiene station.
22. A method according to any one of embodiments 16-21, wherein the optical indicia on the optical identification tag associated with a hygiene station is not a barcode.
23. A method according to any one of embodiments 16-22, wherein each of the hygiene stations comprises two optical identification tags associated therewith, and wherein identifying a characteristic of a selected hygiene station comprises identifying two different optical indicia on the two optical identification tags.
24. A method according to any one of embodiments 16-23, wherein the optical identification tags associated with the hygiene stations are adhesively attached to a surface on or near a hygiene station.
25. A method according to any one of embodiments 16-24, wherein the optical sensor comprises a camera.
26. A method according to any one of embodiments 16-25, wherein the transient credential comprises a light source, and wherein the method of identifying the optical indicia on the optical identification tags comprises emitting light of a selected wavelength.
27. A method according to embodiment 26, wherein the optical indicia selectively reflects or absorbs the light emitted by the light source.
28. A method according to any one of embodiments 16-27, wherein the method further comprises determining a distance between the optical sensor and the optical indicia on the optical identification tags.
29. A method according to any one of embodiments 16-28, wherein the controller comprises a patient zone controller, and wherein the method comprises defining a patient zone proximate only one selected patient using the patient zone controller.
30. A method according to embodiment 29, wherein the method comprises detecting entry and/or exit of a transient credential of the plurality of transient credentials relative to the patient zone.

The complete disclosure of the patents, patent documents, and publications cited herein are incorporated by reference in their entirety as if each were individually incorporated.

Exemplary embodiments of systems and methods of monitoring hygiene protocol compliance in a health care facility have been discussed and reference has been made to possible variations. These and other variations and modifications will be apparent to those skilled in the art without departing from the scope of the invention, and it should be understood that the invention is not limited to the illustrative embodiments set forth herein. Accordingly, the invention is to be limited only by the claims provided below and equivalents thereof.

1. A system for monitoring hygiene protocol compliance in a health care facility, the system comprising:
a plurality of hygiene stations;
an optical identification tag associated with each hygiene station of the plurality of hygiene stations, wherein the associated optical identification tag is located on or near the hygiene station and comprises optical indicia indicative of a characteristic of the hygiene station;
a plurality of transient credentials, wherein each transient credential of the plurality of transient credentials comprises an optical sensor configured to detect the optical indicia on the optical identification tag associated with each hygiene station, and wherein the transient credential is configured to identify the characteristic of the hygiene station indicated by the optical indicia detected by the optical sensor;
an optional controller, wherein the plurality of transient credentials are operably connected to the controller through a communication link that comprises communication devices in the plurality of transient credentials;
wherein the system is configured to associate a cleaning event at a selected hygiene station with a selected transient credential based on detection of the optical indicia of the optical identification tag associated with the selected hygiene station by the optical sensor of the selected transient credential.

2. A system according to claim 1, wherein the system further comprises an optical identification tag associated with a patient in the health care facility, wherein the patient-associated optical identification tag is located on or near the patient and comprises optical indicia indicative of a characteristic of the patient;
wherein the optical sensor of each transient credential of the plurality of transient credentials is configured to detect the optical indicia on the optical identification tag associated with the patient, and wherein the transient credential is configured to identify the characteristic of the patient indicated by the optical indicia detected by the optical sensor;
wherein the system is configured to determine if the cleaning event at the selected hygiene station is a proper cleaning event for the patient based on the characteristic of the patient indicated by the optical indicia on the optical identification tag associated with the patient.

3. A system according to claim 1, wherein the system further comprises an optical identification tag associated with a health care bundle, wherein the bundle-associated optical identification tag is located on the health care bundle and comprises optical indicia indicative a characteristic of the health care bundle;
wherein the optical sensor of each transient credential of the plurality of transient credentials is configured to detect the optical indicia on the optical identification tag associated with the health care bundle, and wherein the transient credential is configured to identify the characteristic of the health care bundle indicated by the optical indicia detected by the optical sensor;
wherein the system is configured to determine if the cleaning event at the selected hygiene station is a proper cleaning event for the health care bundle based on the characteristic of the health care bundle indicated by the optical indicia on the optical identification tag associated with the health care bundle.

4. A system according to claim 1, wherein the characteristic identified by the optical indicia on the optical identification tag associated with a hygiene station comprises the location of the hygiene station.

5. A system according to claim 1, wherein the characteristic identified by the optical indicia on the optical identification tag associated with a hygiene station comprises the type of the hygiene station.

6. A system according to claim 1, wherein the characteristic identified by the indicia on the optical identification tag associated with a hygiene station comprises data identifying a patient associated with the hygiene station.

7. A system according to claim 1, wherein each of the hygiene stations comprises two optical identification tags associated therewith, wherein each optical identification tag of the two optical identification tags comprises different optical indicia identifying a different characteristic of the hygiene station associated with the two optical identification tags.

8. A system according to claim 1, wherein the optical sensor comprises a camera.

9. A system according to claim 1, wherein the transient credential comprises a light source emitting light of a selected wavelength, and wherein the optical indicia selectively reflects or absorbs the light emitted by the light source.

10. A system according to claim 1, wherein the optical sensor and/or the optical indicia are configured to provide a distance determination indicative of the distance between the optical sensor and the optical indicia.

11. A system according to claim 1, wherein the controller comprises a patient zone controller, and wherein the system comprises data associating the patient zone controller with only one selected patient, and further wherein the patient zone controller is configured to define a patient zone proximate the selected patient.

12. A system according to claim 11, wherein the patient zone controller is configured to detect entry and/or exit of a transient credential of the plurality of transient credentials relative to the patient zone.

13. A method of monitoring hygiene protocol compliance in a health care facility, the method comprising:
associating a plurality of optical identification tags with a plurality of hygiene stations, wherein at least one optical identification tag is associated with each hygiene station, wherein the at least one optical identification tag is located on or near the associated hygiene station and comprises optical indicia indicative of a characteristic of the associated hygiene station; and
monitoring hygiene protocol compliance associated with a selected transient credential by:
identifying a characteristic of a selected hygiene station by detecting optical indicia on an optical identification tag associated with a selected hygiene station using an optical sensor of the selected transient credential;
associating a cleaning event at the selected hygiene station with the selected transient credential based on detection of the optical indicia of the optical identification tag associated with the selected hygiene station by the optical sensor of the selected transient credential.

14. A method according to claim 13, the method further comprising:
associating an optical identification tag with a selected patient, wherein the optical identification tag is located on or near the selected patient and comprises optical indicia indicative of a characteristic of the selected patient;
wherein monitoring the hygiene protocol compliance associated with the selected transient credential comprises:
identifying a characteristic of the selected patient by detecting optical indicia on the optical identification tag associated with the selected patient using an optical sensor of the selected transient credential; and
determining if the cleaning event at the selected hygiene station is a proper cleaning event for the selected patient based on the characteristic of the selected patient indicated by the optical indicia on the optical identification tag associated with the selected patient.

15. A method according to claim 13, the method further comprising:
associating a plurality of optical identification tags with a plurality of health care bundles, wherein at least one optical identification tag is associated with each health care bundle, wherein the at least one optical identification tag is located on or near the associated health care bundle and comprises optical indicia indicative of a characteristic of the associated health care bundle;
wherein monitoring the hygiene protocol compliance associated with the selected transient credential comprises:
identifying a characteristic of a selected health care bundle by detecting optical indicia on an optical identification tag associated with the selected health care bundle using an optical sensor of the selected transient credential; and
determining if the cleaning event at the selected hygiene station is a proper cleaning event for the selected health care bundle based on the characteristic of the selected health care bundle indicated by the optical indicia on the optical identification tag associated with the selected health care bundle.

16. A method according to claim 13, wherein the characteristic identified by the optical indicia on the optical identification tag associated with a hygiene station comprises the location of the hygiene station.

17. A method according to of claim 13, wherein the characteristic identified by the indicia on the optical identification tag associated with a hygiene station comprises data identifying a patient associated with the hygiene station.

18. A method according to claim 13, wherein each of the hygiene stations comprises two optical identification tags associated therewith, and wherein identifying a characteristic of a selected hygiene station comprises identifying two different optical indicia on the two optical identification tags.

19. A method according to claim 13, wherein the transient credential comprises a light source, and wherein the method of identifying the optical indicia on the optical identification tags comprises emitting light of a selected wavelength, and wherein the optical indicia selectively reflects or absorbs the light emitted by the light source.

20. A method according to claim 13, wherein the controller comprises a patient zone controller, and wherein the method comprises defining a patient zone proximate only one selected patient using the patient zone controller.

21. A method according to claim 20, wherein the method comprises detecting entry and/or exit of a transient credential of the plurality of transient credentials relative to the patient zone.
